(19) United States
(12) Patent Application Publication
(10) Pub. No.: US 2020/0090299 A1
(43) Pub. Date: Mar. 19, 2020

(54) THREE-DIMENSIONAL SKELETON INFORMATION GENERATING APPARATUS

(71) Applicant: AISIN SEIKI KABUSHIKI KAISHA, Kariya-shi (JP)

(72) Inventors: Osamu UNO, Kasuya-gun (JP); Satoshi MORI, Kasuya-gun (JP); Takuro OSHIDA, Anjo-shi (JP); Shingo FUJIMOTO, Tokai-shi (JP); Hiroyuki MORISAKI, Kitakyushu-shi (JP)

(73) Assignee: AISIN SEIKI KABUSHIKI KAISHA, Kariya-shi (JP)

(21) Appl. No.: 16/565,732

(22) Filed: Sep. 10, 2019

(30) Foreign Application Priority Data
Sep. 13, 2018 (JP) 2018-171909

(51) Int. Cl. G06T 3/00; G06T 7/73; G06T 1/00; G06K 9/00

(52) U.S. Cl. CPC G06T 3/0031; G06T 7/73; G06T 1/0007; G06T 2207/20044; G06T 2200/04; G06T 2207/30268; G06K 9/00369

(57) ABSTRACT

A three-dimensional skeleton information generating apparatus includes an acquisition portion acquiring a two-dimensional image and a distance image of a subject, and a coordinate estimation portion estimating a three-dimensional coordinate of a skeleton point of the subject in a three-dimensional absolute coordinate system based on the two-dimensional image and the distance image acquired by the acquisition portion, the three-dimensional absolute coordinate system including a position other than an imaging position of the two-dimensional image and the distance image as an origin.

### CROSS REFERENCE TO RELATED APPLICATIONS

This application is based on and claims priority under 35 U.S.C. § 119 to Japanese Patent Application 2018-171909, filed on Sep. 13, 2018, the entire content of which is incorporated herein by reference.

### TECHNICAL FIELD

This disclosure generally relates to a three-dimensional skeleton information generating apparatus.

### BACKGROUND DISCUSSION

A known technique for estimating a two-dimensional (2D) coordinate of a skeleton point of a human body based on a 2D image captured by an imaging device is disclosed, for example, in JP2017-199303A.

The 2D coordinate of the skeleton point obtained in JP2017-199303A, for example, is based on the 2D image captured by the imaging device. Therefore, the 2D coordinate serves as information which depends on an imaging environment of the imaging device, i.e., a posture (direction), a position, and a type of the imaging device, for example.

A need thus exists for a three-dimensional skeleton information generating apparatus which is not susceptible to the drawback mentioned above.

### SUMMARY

According to an aspect of this disclosure, a three-dimensional skeleton information generating apparatus includes an acquisition portion acquiring a two-dimensional image and a distance image of a subject, and a coordinate estimation portion estimating a three-dimensional coordinate of a skeleton point of the subject in a three-dimensional absolute coordinate system based on the two-dimensional image and the distance image acquired by the acquisition portion, the three-dimensional absolute coordinate system including a position other than an imaging position of the two-dimensional image and the distance image as an origin.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating an interior of a vehicle at which a three-dimensional skeleton information generating apparatus is mounted according to a first embodiment disclosed here;

FIG. 2 is a block diagram illustrating a configuration of a control system according to the first embodiment;

FIG. 3 is a block diagram illustrating a functional configuration of an ECU according to the first embodiment;

FIG. 4 is a diagram illustrating an example of 2D skeleton information;

FIG. 5 is a diagram illustrating an example of 3D skeleton information;

FIG. 6 is a diagram explaining human body statistics information;

FIG. 7 is a flowchart illustrating a processing performed by the ECU according to the first embodiment;

FIG. 8 is a block diagram illustrating a functional configuration of an ECU according to a second embodiment disclosed here;

FIG. 9 is a diagram illustrating an example of a 3D point group; and

FIG. 10 is a flowchart illustrating a processing performed by the ECU according to the second embodiment.

### DETAILED DESCRIPTION

A three-dimensional (3D) skeleton information generating apparatus according to embodiments is explained with reference to the attached drawings. The 3D skeleton information generating apparatus, however, is not limited to the following configurations. The same components between first and second embodiments bear the same reference numerals and duplication of explanation is avoided.

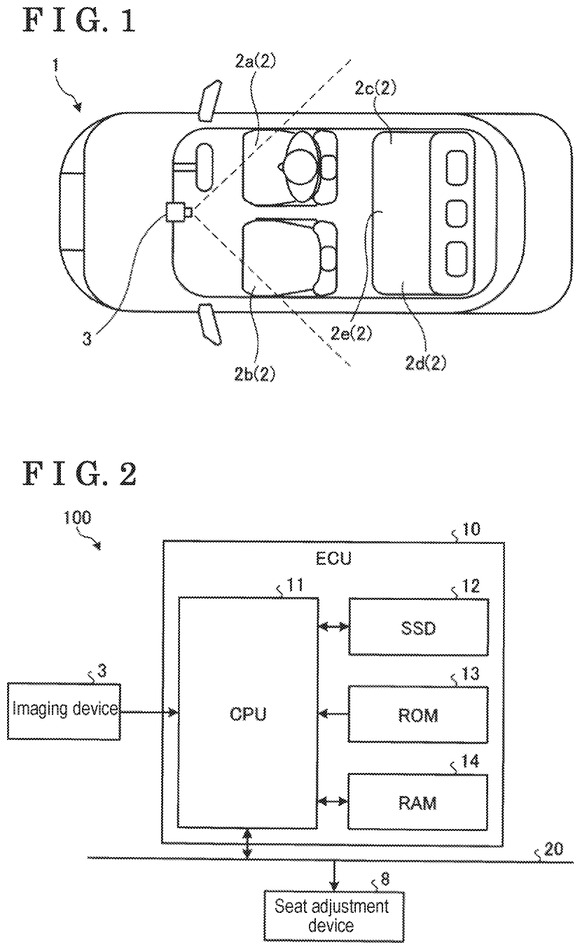

A first embodiment is explained as below. As illustrated in FIG. 1, plural seats 2 are provided at an interior (a vehicle interior) of a vehicle 1. For example, the plural seats 2 include a driver seat 2a and a passenger seat 2b at a front side in the vehicle interior, and plural rear seats 2c, 2d, and 2e. The rear seat 2c is provided behind the driver seat 2a while the rear seat 2d is provided behind the passenger seat 2b. The rear seat 2e is provided between the rear seats 2c and 2d.

An imaging device 3 is provided at a front portion in the vehicle interior. The imaging device 3 is a Time-of-Flight (TOF) distance image camera, for example. The imaging device 3 captures a two-dimensional (2D) image and a subject, i.e., a 2D image where a passenger (passengers) at the vehicle interior is captured, and a distance image including distance information as a pixel value from an imaging position of the imaging device 3 to the passenger.

In the first embodiment, a direction, an angle of view, and an installation position of the imaging device 3, for example, are determined so that all the seats 2 at the vehicle interior can be imaged, i.e., all passengers on the seats 2 can be imaged, by the imaging device 3. For example, the imaging device 3 may be mounted at a dashboard, a room mirror, or a ceiling. Alternatively, the imaging device 3 may be arranged at a position so as to image and capture only a passenger seated on a specific seat 2 (for example, the driver seat 2a).

In the embodiment, the single imaging device 3 captures both the 2D image and the distance image. Alternatively, for example, an imaging device that captures the 2D image and an imaging device that captures the distance image may be separately provided at the vehicle 1. The imaging device capturing the distance image is not limited to the TOF distance image camera and may be a stereo camera or a structured-light 3D scanner, for example.

A control system 100 including the 3D skeleton information generating apparatus is mounted at the vehicle 1. The configuration of the control system 100 is explained with reference to FIG. 2.

As illustrated in FIG. 2, the control system 100 includes the imaging device 3, a seat adjustment device 8, an electronic control unit (ECU) 10, and an in-vehicle network 20. The ECU 10 serves as an example of the 3D skeleton information generating apparatus.

The imaging device 3 is connected to the ECU 10 via an output line of a national television system committee (NTSC) cable, for example. The imaging device 3 outputs the captured 2D image and distance image to the ECU 10 via the output line.

The seat adjustment device 8 adjusts the position of the seat 2. For example, the seat adjustment device 8 adjusts the position of the driver seat 2a. Alternatively, the seat adjustment device 8 may adjust the position of the seat 2 other than the driver seat 2a. The seat adjustment device 8 adjusts the position of the driver seat 2a in a front-rear direction thereof. Alternatively, the seat adjustment device 8 may adjust a height position of the driver seat 2a, for example.

The ECU 10 controls the seat adjustment device 8 by sending a control signal via the in-vehicle network 20. The ECU 10 may also perform controls of brake system and steering system, for example.

The ECU 10 includes a central processing unit (CPU) 11, a solid state drive (SSD) 12, a read only memory (ROM) 13, and a random access memory (RAM) 14, for example. The CPU 11 executes program stored at a non-volatile storage unit such as the ROM 13, for example, to realize the function as the 3D skeleton information generating apparatus. The RAM 14 tentatively stores various data utilized for mathematical operation (calculation) at the CPU 11. The SSD 12 is a rewritable non-volatile storage unit and is thus able to store data even in a case where a power source of the ECU 10 is turned off. The CPU 11, the ROM 13, and the RAM 14, for example, may be integrated within the single package. The ECU 10 may be configured to employ other arithmetic logic processor such as a digital signal processor (DSP) and a logic circuit, for example, other than the CPU 11. Instead of the SSD 12, a hard disk drive (HDD) may be provided. The SSD 12 or the HDD may be provided separately from the ECU 10.

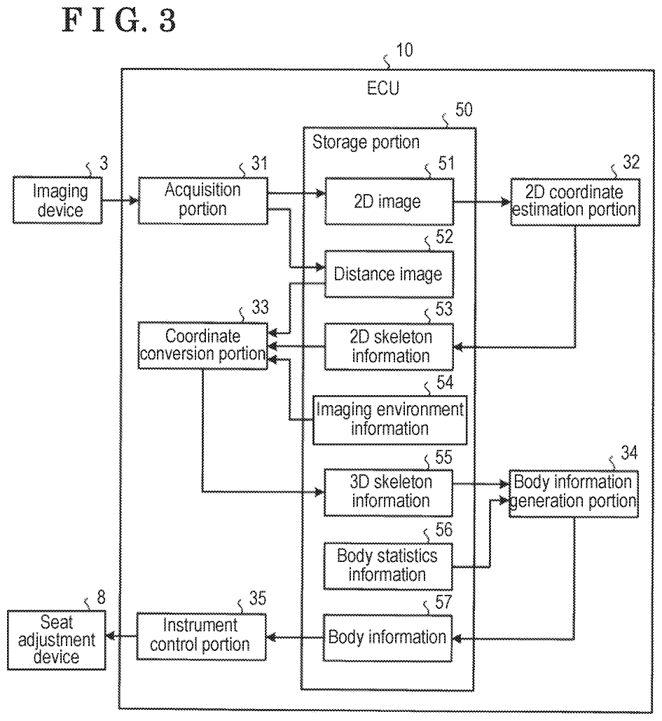

Next, a functional configuration of the ECU 10 is explained with reference to FIG. 3.

As illustrated in FIG. 3, the ECU 10 includes an acquisition portion 31, a 2D coordinate estimation portion 32, a coordinate conversion portion 33, a body information generation portion 34, an instrument control portion 35, and a storage portion 50. The acquisition portion 31, the 2D coordinate estimation portion 32, the coordinate conversion portion 33, the body information generation portion 34, and the instrument control portion 35 are realized by the CPU 11 performing program stored at the ROM 13. The acquisition portion 31, the 2D coordinate estimation portion 32, the coordinate conversion portion 33, the body information generation portion 34, and the instrument control portion 35 may be realized by a hardware circuit. The storage portion 50 is constituted by the SSD 12, for example.

The acquisition portion 31 acquires the 2D image and the distance image captured by the imaging device 3 from the imaging device 3. The acquisition portion 31 stores the acquired 2D image and the distance image at the storage portion 50 (corresponding to a 2D image 51 and a distance image 52).

The 2D coordinate estimation portion 32 extracts skeleton points of a passenger imaged and captured within the 2D image 51 based on the 2D image 51 stored at the storage portion 50. The skeleton points correspond to feature points indicating positions of respective portions of the passenger (i.e., a subject or an object) and include end points on the body (upper and lower end portions of the face, for example) and joints (a base of arm (shoulder joint), a base of leg (groin), and a wrist, for example).

The 2D coordinate estimation portion 32 generates 2D skeleton information 53 including respective positions of the extracted skeleton points which are indicated as 2D coordinates and stores the aforementioned 2D skeleton information 53 at the storage portion 50.

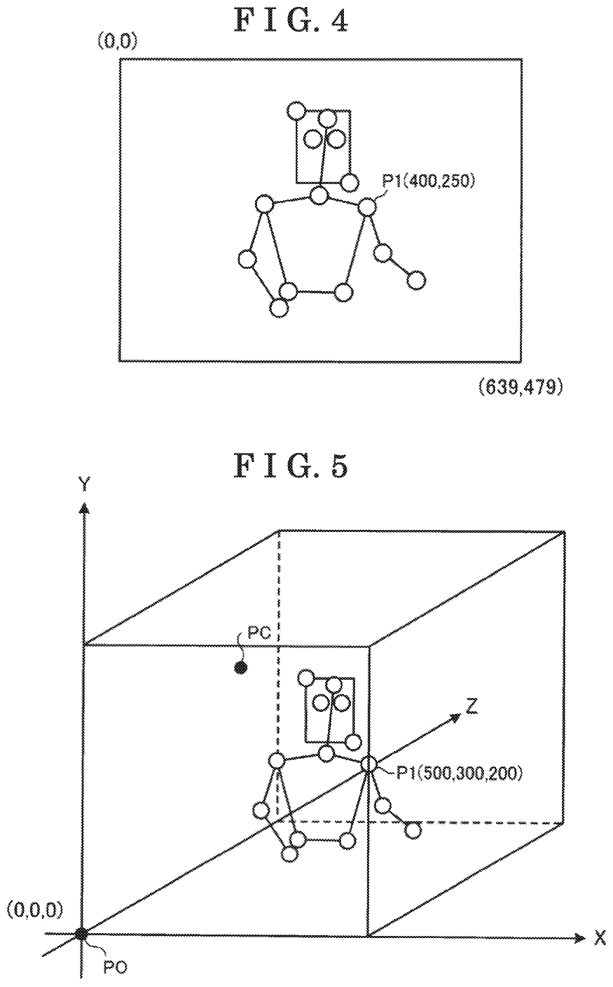

An example of the 2D skeleton information 53 is illustrated in FIG. 4. As illustrated in FIG. 4, the 2D skeleton information 53 is represented by a 2D coordinate system where an upper left corner of the 2D image 51 is defined as an origin (0, 0), for example. In the 2D skeleton information 53 as illustrated in FIG. 4, the 2D coordinate of a skeleton point P1 positioned at the base of the left arm of the subject is represented as (400, 250). The 2D coordinate of a lower right corner of the 2D image 51 is represented as (639, 479).

The coordinate conversion portion 33 converts the 2D coordinate estimated by the 2D coordinate estimation portion 32 to a 3D coordinate.

The coordinate conversion portion 33 specifies a distance from the imaging position of the imaging device 3 to each skeleton point based on the distance image 52 and the 2D skeleton information 53. Specifically, the coordinate conversion portion 33 acquires distance information assigned to pixels on the 2D image 51 and corresponding to the 2D coordinate of each skeleton point. As a result, the distance from each skeleton point to the imaging position is identifiable.

Next, the coordinate conversion portion 33 converts the 2D coordinate of each skeleton point to the 3D coordinate based on the 2D coordinate of each skeleton point, a distance from each skeleton point to the imaging position, and imaging environment information 54. The imaging environment information 54 serves as information including position and posture of the imaging device 3 in a 3D absolute coordinate system, a type of lens, and values of various parameters at the time of imaging, for example. With the imaging environment information 54, the position of each skeleton point may be indicated as the 3D coordinate in the 3D absolute coordinate system including an origin that is different from the imaging position of the imaging device 3. The coordinate conversion portion 33 generates 3D skeleton information 55.

The coordinate conversion portion 33 generates the 3D skeleton information 55 representing the position of each skeleton point by the 3D coordinate in the 3D absolute coordinate system and stores the aforementioned 3D skeleton information 55 at the storage portion 50.

An example of the 3D skeleton information 55 is illustrated in FIG. 5. As illustrated in FIG. 5, the 3D absolute coordinate system is a 3D coordinate system where a position different from an imaging position PC of the imaging device 3 is defined as an origin PO. For example, the 3D coordinate of the skeleton point P1 of which 2D coordinate is (400, 250) in the 2D skeleton information 53 is represented as a value (500, 300, 200) in the 3D absolute coordinate system as illustrated in FIG. 5. The aforementioned value in the 3D absolute coordinate system is an actual value of distance from the origin PO (0, 0, 0) of the 3D absolute coordinate system to the skeleton point P1. That is, the 3D coordinate (500, 300, 200) of the skeleton point P1 indicates that the skeleton point P1 is positioned 500 mm in an X-axis direction, 300 mm in a Y-axis direction, and 200 mm in a Z-axis direction from the origin PO (0, 0, 0).

According to the coordinate conversion portion 33, the 2D coordinate in the 2D skeleton information 53 represented by the 2D coordinate system which depends on an imaging environment such as the position and the direction of the imaging device 3 and the type of lens, for example, is able to be converted to the 3D coordinate in the 3D absolute coordinate system which is inhibited from depending on the imaging environment. Accordingly, being different from a case where body information (such as a shoulder-width, for example) of a passenger is recognized on a basis of the 2D coordinate of the skeleton points obtained from the 2D image, machine learning depending on individual imaging environment is not necessary, which may constitute passenger recognition logic with high versatility. That is, under any imaging environments, the body information of the passenger is recognizable without machine learning depending on such imaging environments.

The body information generation portion 34 calculates the body information including a length of each portion of the passenger based on the 3D skeleton information 55 stored at the storage portion 50. For example, the body information generation portion 34 calculates a distance between the skeleton point P1 positioned at the base of the left arm and a skeleton point positioned at the base of the right arm using the 3D coordinates of the aforementioned skeleton point P1 and the skeleton point to thereby obtain information of the shoulder-width of the passenger. As mentioned above, because the 3D coordinate of each skeleton point in the 3D skeleton information 55 is represented as actual dimension (actual value), the length of each portion of the passenger may be easily calculated by geometric calculation.

The body information generation portion 34 calculates the length of each portion of the passenger which is actually captured in the 2D image 51. For example, the body information generation portion 34 calculates the length of each portion of the upper body of the passenger (shoulder-width, length of the upper arm, head-width, for example). In addition, the body information generation portion 34 estimates the body information of a portion of the passenger not captured in the 2D image by human body statistics information (body statistics information) 56 stored at the storage portion 50.

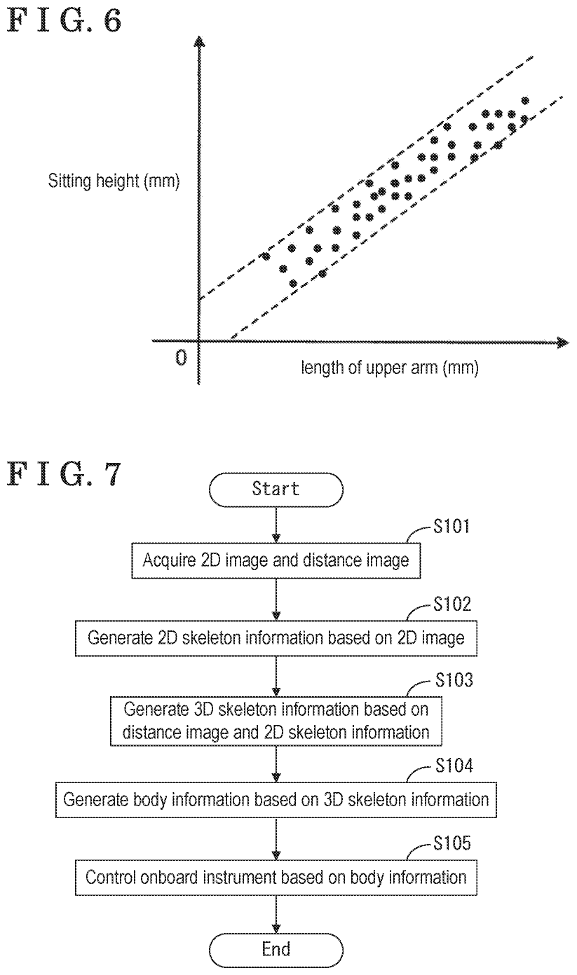

For example, in a case where a correlation is obtained between the length of the upper arm and the sitting height as illustrated in FIG. 6, the body statistics information 56 includes a correlation formula representing the aforementioned correlation. The sitting height which does not appear in the 2D image 51 may be estimated on a basis of the length of the upper arm calculated from the 3D skeleton information 55 and the aforementioned correlation formula. The correlation illustrated in FIG. 6 is an example and the body statistics information 56 includes plural formulas indicating the correlation between the length of one portion and the length of the other portion.

Accordingly, the body information generation portion 34 generates the body information and stores the generated body information at the storage portion 50 (corresponding to body information 57).

The instrument control portion 35 controls various instruments (equipment) mounted at the vehicle 1 based on the body information 57 stored at the storage portion 50. As an example, the instrument control portion 35 controls the seat adjustment device 8 based on the body information 57 so as to automatically adjust the position of the seat 2 (the driver seat 2a, for example) depending on the height of the passenger, for example. The passenger can save time and effort for adjusting the position of the seat 2 by herself/himself.

Not limited to the aforementioned example, the instrument control portion 35 may switch a development mode of an air bag device to a weak development mode where an air bag is developed weaker than a normal mode for adult, by determining that the passenger is a child in a case where the shoulder-width of the passenger included in the body information 57 is equal to or smaller than a threshold value. Accordingly, the air bag is developed with intensity which depends on physique of the passenger to enhance safety of the air bag.

Next, detailed operation of the ECU 10 is explained with reference to FIG. 7.

As illustrated in FIG. 7, the acquisition portion 31 acquires the 2D image 51 and the distance image 52 from the acquisition portion 31 (step S101). The 2D coordinate estimation portion 32 generates, on a basis of the 2D image 51, the 2D skeleton information 53 indicating the 2D coordinate of each skeleton point of the passenger in the 2D coordinate system with reference to the 2D image 51 (step S102).

Next, the coordinate conversion portion 33 converts the 2D coordinate in the 2D skeleton information 53 to the 3D coordinate in the 3D absolute coordinate system which is inhibited from depending on the imaging environment based on the distance image 52, the 2D skeleton information 53, and the imaging environment information 54, for example (step S103).

The body information generation portion 34 then generates the body information 57 based on the 3D skeleton information 55 (step S104). The instrument control portion 35 controls an onboard instrument such as the seat adjustment device 8, for example, based on the body information 57 (step S105).

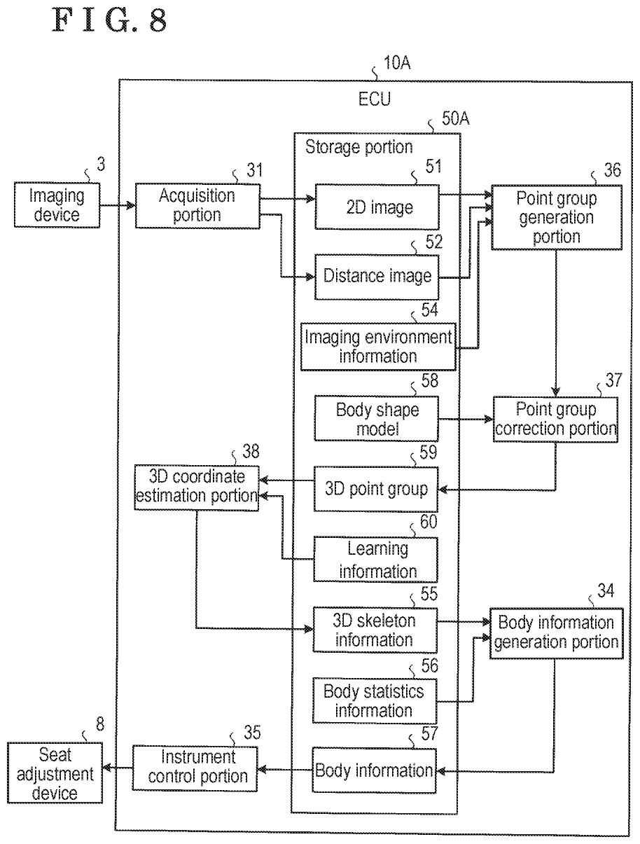

Next, the 3D skeleton information generating apparatus according to a second embodiment is explained with reference to FIG. 8.

As illustrated in FIG. 8, an ECU 10A according to the second embodiment includes a point group generation portion 36, a point group correction portion 37, and a 3D coordinate estimation portion 38, instead of the 2D coordinate estimation portion 32 and the coordinate conversion portion 33.

The point group generation portion 36 performs a geometric calculation based on the 2D image 51, the distance image 52, and the imaging environment information 54 stored at a storage portion 50A to generate a 3D point group of a passenger in the 3D absolute coordinate system.

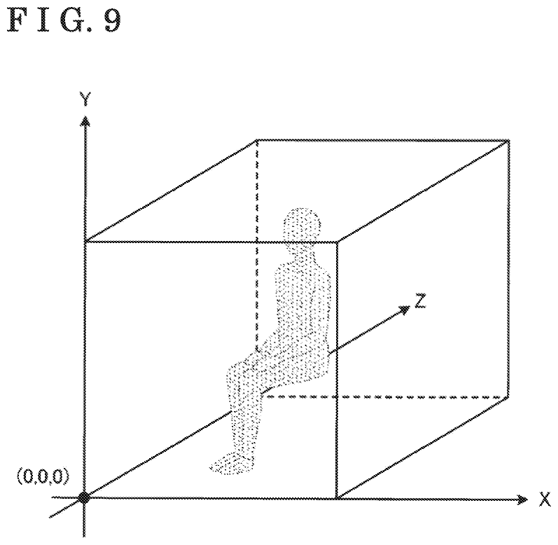

As illustrated in FIG. 9, the 3D point group generated by the point group generation portion 36 is a group of a number of points indicating the configuration of the surface of the passenger (including a surface of clothing). The 3D point group does not include information of the inner portion of the passenger, i.e., the skeleton of the passenger.

In addition, as illustrated in FIG. 9, the point group generation portion 36 performs coordinate conversion by using the imaging environment information 54 from the 2D coordinate system serving as a relative coordinate system based on the 2D image 51 to the 3D absolute coordinate system which is inhibited from depending on the imaging environment.

The point group generation portion 36 outputs the generated 3D point group to the point group correction portion 37. Any known technique may be applied to a method of generating the 3D point group.

The point group correction portion 37 corrects the 3D point group generated by the point group generation portion 36 based on a human body shape model (body shape model) 58 stored at the storage portion 50A. The body shape model 58 serves as information obtained by modeling a 3D shape (3D configuration) of a human body.

The 3D point group generated by the point group generation portion 36 may include a shape (configuration) which is impossible as a human body, such as a shape of a face that is dented deeply and a configuration where a projection protrudes from a chest portion, for example, as noise. The point group correction portion 37 eliminates or corrects such shape (configuration) which is impossible as a human body by means of the body shape model 58. The noise included in the 3D point group generated by the point group generation portion 36 is removable. The point group generation portion 36 stores the 3D point group where the noise is removed at the storage portion 50A (corresponding to a 3D point group 59).

The 3D coordinate estimation portion 38 estimates the 3D coordinate of each skeleton point in the 3D absolute coordinate system based on the 3D point group 59 stored at the storage portion 50A and learning information 60.

The learning information 60 is obtained by giving a great number of learning data indicating a surface shape of a human body and correct data indicating a position of each skeleton point in each of the learning data to a learning machine so that the learning machine learns. The 3D coordinate estimation portion 38 estimates the position of each skeleton point of the passenger by using the learning information 60 based on an outline (outer shape) of the passenger indicated by the 3D point group 59.

The 3D coordinate estimation portion 38 generates the 3D skeleton information indicating the 3D coordinate of each skeleton point of the passenger and stores the generated 3D skeleton information at the storage portion 50A (corresponding to the 3D skeleton information 55).

Accordingly, being different from the 2D image 51, the 3D point group 59 includes information of a surface shape of a human body (a roundness of an arm and a shape of a body, for example) and thus directly estimates the position of the skeleton point within the human body based on the 3D point group 59 and the learning information 60 stored beforehand. The 3D point group 59 obtains highly accurate 3D skeleton information which is unlikely to be influenced by whether the passenger is fat (well-fleshed) or thin or by clothing, for example.

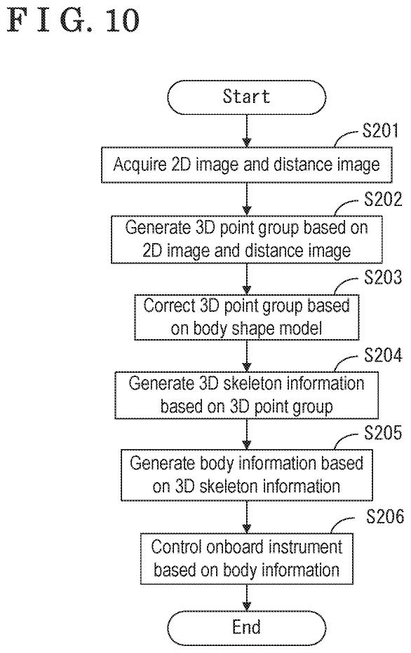

Next, detailed operation of the ECU 10A according to the second embodiment is explained with reference to FIG. 10.

As illustrated in FIG. 10, the acquisition portion 31 acquires the 2D image 51 and the distance image 52 from the imaging device 3 (step S201). The point group generation portion 36 generates the 3D point group 59 of the passenger of which position is defined by the 3D absolute coordinate system based on the 2D image 51 and the distance image 52 (step S202). The point group correction portion 37 corrects the 3D point group generated by the point group generation portion 36 based on the body shape model 58 (step S203).

Next, the 3D coordinate estimation portion 38 converts the 2D coordinate serving as a relative coordinate with reference to the 2D image 51 to the 3D coordinate which is inhibited from depending on the imaging environment to generate the 3D skeleton information 55 based on the 3D point group 59 corrected by the point group correction portion 37 (step S204).

The body information generation portion 34 then generates the body information 57 based on the 3D skeleton information 55 (step S205). The instrument control portion 35 controls the onboard instrument such as the seat adjustment device 8, for example, based on the body information 57 (step S206).

As mentioned above, the 3D skeleton information generating apparatus according to the first and second embodiments (i.e., the ECU 10, 10A, for example) includes the acquisition portion 31, the coordinate estimation portion (the 2D coordinate estimation portion 32 and the coordinate conversion portion 33, or the point group generation portion 36 and the 3D coordinate estimation portion 38, for example). The acquisition portion 31 acquires the 2D image 51 and the distance image 52 of a subject (i.e., a passenger of the vehicle 1, for example). The coordinate estimation portion estimates the 3D coordinate of the skeleton point of the subject in the 3D absolute coordinate system including the position other than the imaging position of the 2D image 51 and the distance image 52 as the origin based on the 2D image 51 and the distance image 52 acquired by the acquisition portion 31.

Accordingly, the 3D coordinate of the skeleton point of the subject in the 3D absolute coordinate system including the position other than the imaging position of the 2D image 51 and the distance image 52 as the origin is estimated to generate the skeleton information which is inhibited from depending on the imaging environment.

The coordinate estimation portion may include the 2D coordinate estimation portion 32 and the coordinate conversion portion 33. The 2D coordinate estimation portion 32 estimates the 2D coordinate of the skeleton point based on the 2D image 51. The coordinate conversion portion 33 converts the 2D coordinate estimated by the 2D coordinate estimation portion 32 to the 3D coordinate in the 3D absolute coordinate system based on the distance image 52. Accordingly, the 2D coordinate of the skeleton point represented as in the 2D coordinate system which depends on the imaging environment is able to be converted to the 3D coordinate in the 3D absolute coordinate system which is inhibited from depending on the imaging environment.

The coordinate estimation portion may include the point group generation portion 36 and the 3D coordinate estimation portion 38. The point group generation portion 36 generates the 3D point group of the subject in the 3D absolute coordinate system based on the 2D image 51 and the distance image 52. The 3D coordinate estimation portion 38 estimates the 3D coordinate of the skeleton point in the 3D absolute coordinate system based on the 3D point group generated by the point group generation portion 36. Accordingly, because the position of the skeleton point at the inside of the human body is directly estimated, the highly accurate 3D skeleton information which is unlikely to be influenced by whether the passenger is fat (well-fleshed) or thin or by clothing, for example, is obtainable.

The coordinate estimation portion may include the point group correction portion 37 correcting the 3D point group generated by the point group generation portion 36 based on the human body shape model obtained by modelling the 3D shape of the human body. As a result, noise included in the 3D point group is removable.

The 3D skeleton information generating apparatus may include the body information generation portion 34 generating the body information 57 including a length of a portion of a subject based on the 3D coordinate of the skeleton point estimated by the coordinate estimation portion. Accordingly, being different from a case where the body information of the subject is recognized from the 2D coordinate of the skeleton point obtained from the 2D image 51, for example, machine learning depending on individual imaging environment is not necessary, which leads to construction of recognition logic with high versatility. That is, under any imaging environment, the body information of the subject is recognizable without machine learning that depends on the corresponding imaging environment.

According to the aforementioned embodiments, a three-dimensional skeleton information generating apparatus 10, 10A includes an acquisition portion 31 acquiring a two-dimensional image and a distance image of a subject, and a coordinate estimation portion 32, 33, 36, 38 estimating a three-dimensional coordinate of a skeleton point of the subject in a three-dimensional absolute coordinate system based on the two-dimensional image and the distance image acquired by the acquisition portion 31, the three-dimensional absolute coordinate system including a position other than an imaging position of the two-dimensional image and the distance image as an origin.

Accordingly, skeleton information which is inhibited from depending on an imaging environment may be generated.

In addition, according to the first embodiment, the coordinate estimation portion 32, 33 includes a two-dimensional coordinate estimation portion 32 estimating a two-dimensional coordinate of the skeleton point based on the two-dimensional image, and a coordinate conversion portion 33 converting the two-dimensional coordinate estimated by the two-dimensional coordinate estimation portion 32 to the three-dimensional coordinate in the three-dimensional absolute coordinate system based on the distance image.

Accordingly, the two-dimensional 2D coordinate of the skeleton point represented as in a 2D coordinate system which depends on the imaging environment is converted to the 3D coordinate in the 3D absolute coordinate system which is inhibited from depending on the imaging environment.

According to the second embodiment, the coordinate estimation portion 36, 38 includes a point group generation portion 36 generating a three-dimensional point group of the subject in the three-dimensional absolute coordinate system based on the two-dimensional image and the distance image and a three-dimensional coordinate estimation portion 38 estimating the three-dimensional coordinate of the skeleton point in the three-dimensional absolute coordinate system based on the three-dimensional point group generated by the point group generation portion 36.

Accordingly, because the position of the skeleton point is directly estimated, highly accurate 3D skeleton information which is unlikely to be influenced by whether the subject is fat (well-fleshed) or thin or by clothing, for example, is obtainable.

According to the second embodiment, the coordinate estimation portion 36, 38 includes a point group correction portion 37 correcting the three-dimensional point group generated by the point group generation portion 36 based on a human body shape model obtained by modelling a three-dimensional shape of a human body.

Accordingly, possible noise included in the 3D point group is removable.

According to the first and second embodiments, the three-dimensional skeleton information generating apparatus 10, 10A further includes a body information generation portion 34 generating body information including a length of a portion of the subject based on the three-dimensional coordinate of the skeleton point estimated by the coordinate estimation portion 36, 38.

Accordingly, being different from a case where the body information of the subject is recognized on a basis of the 2D coordinate of the skeleton point obtained from the 2D image 51, for example, machine learning depending on individual imaging environment is not necessary, which may constitute recognition logic with high versatility. That is, under any imaging environment, the body information of the subject is recognizable without machine learning depending on such imaging environment.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A three-dimensional skeleton information generating apparatus, comprising:
an acquisition portion acquiring a two-dimensional image and a distance image of a subject; and
a coordinate estimation portion estimating a three-dimensional coordinate of a skeleton point of the subject in a three-dimensional absolute coordinate system based on the two-dimensional image and the distance image acquired by the acquisition portion, the three-dimensional absolute coordinate system including a position other than an imaging position of the two-dimensional image and the distance image as an origin.

2. The three-dimensional skeleton information generating apparatus according to claim 1, wherein the coordinate estimation portion includes a two-dimensional coordinate estimation portion estimating a two-dimensional coordinate of the skeleton point based on the two-dimensional image, and a coordinate conversion portion converting the two-dimensional coordinate estimated by the two-dimensional coordinate estimation portion to the three-dimensional coordinate in the three-dimensional absolute coordinate system based on the distance image.

3. The three-dimensional skeleton information generating apparatus according to claim 1, wherein the coordinate estimation portion includes:
a point group generation portion generating a three-dimensional point group of the subject in the three-dimensional absolute coordinate system based on the two-dimensional image and the distance image; and
a three-dimensional coordinate estimation portion estimating the three-dimensional coordinate of the skeleton point in the three-dimensional absolute coordinate system based on the three-dimensional point group generated by the point group generation portion.

4. The three-dimensional skeleton information generating apparatus according to claim 3, wherein the coordinate estimation portion includes a point group correction portion correcting the three-dimensional point group generated by the point group generation portion based on a human body shape model obtained by modelling a three-dimensional shape of a human body.

5. The three-dimensional skeleton information generating apparatus according to claim 1, further comprising a body information generation portion generating body information including a length of a portion of the subject based on the three-dimensional coordinate of the skeleton point estimated by the coordinate estimation portion.
